(19) United States
(12) Patent Application Publication
(10) Pub. No.: US 2026/0154311 A1
(43) Pub. Date: Jun. 4, 2026

(54) AUTOMATIC LOG DATA CONSOLIDATION AND DIAGNOSTIC ANALYTICS

(71) Applicant: Wells Fargo Bank, N.A., San Francisco, CA (US)

(72) Inventor: Umesh Khandelwal, Charlotte, NC (US)

(21) Appl. No.: 18/966,983

(22) Filed: Dec. 3, 2024

(51) Int. Cl. G06F 16/334; G06F 40/30

(52) U.S. Cl. CPC G06F 16/3347; G06F 40/30

(57) ABSTRACT

A computing system is described that includes memory and one or more processors that are configured to stream log data in real-time from a plurality of data containers associated with a plurality of robotic process automation (RPA) tools and transform, in real-time, by one or more embedding models, the log data into vectors for storage in a vector database. The computing system receives, via a user interface, a user query that identifies at least one RPA tool. The computing system performs a search of the vector database based on the user query to obtain a set of vectorized data, generates a prompt based on the user query and the set of vectorized data, generates, by one or more generative artificial intelligence models based on the prompt, insights related to the query, and transmits the insights to a user device for display.

### TECHNICAL FIELD

This disclosure related to automated computer processes, and more specifically, troubleshooting of issues or errors in automated processes.

### BACKGROUND

Organizations may use automated processes, e.g., robotic process automation (RPA) bots or tools, configured to perform well-defined workflows to complete small, tedious, or repetitive tasks. Automated process tools may be run manually be one or more users or may be automated and/or scheduled processes configured to run in response to one or more triggers, e.g., a specific time, a specific event, receipt of information or instructions from another computing system, or the like.

### SUMMARY

In general, this disclosure describes techniques to provide automated analytics and troubleshooting of issues with robotic process automation (RPA) tools. The disclosed techniques include a computing system configured to perform real-time streaming and consolidation of log data generated by a plurality of RPA tools within an organization and log data generated by a plurality of disparate systems instructed to perform operations by the plurality of RPA tools. The computing system uses one or more embedding models to transform the log data into vectors for storage in a centralized vector database that is searchable based on user queries related to RPA tools. The computing system includes a chatbot or another user interface via which to receive a user query identifying at least one RPA tool. The computing system performs a semantic search of the vector database based on the user query and automatically generates a prompt based on the user query and the log data associated with the at least one RPA tool obtained from the search. The computing system then uses one or more generative artificial intelligence (AI) models to generate one or more insights related to the at least one RPA tool based on the prompt and transmits the one or more insights to a user device for display via the user interface.

The techniques of this disclosure may provide one or more technical advantages that may be used to realize practical advantages. For example, the techniques enable real-time streaming and consolidation of data from logs of, potentially, tens of thousands of RPA tools across an organization as well as logs of a plurality of disparate systems that support the RPA tools. The techniques make this large quantity of log data searchable by vectorizing the log data and organizing the vectorized log data in a vector database by one or more attributes of the log data, such as a name or other identifier of an RPA tool. The vectorized log data, clustered together in groups containing data related to the operation of a particular RPA tool, may be used by the computing system to perform more efficient search and retrieval of all log data associated with the particular RPA tool in response to a user query identifying the particular RPA tool.

As another example, the one or more generative AI models may analyze all the relevant log data associated with the particular RPA tool and determine insights related to the particular RPA tool, e.g., identification of an error or other issue with the RPA tool and/or identification of potential resolutions for the error or other issue. In this way, the disclosed techniques enable efficient troubleshooting by providing real-time analysis of log data associated with RPA tools from across an organization, without requiring IT technicians to manually filter through potentially hundreds of logs spread across multiple devices or servers. This, in turn, allows for less downtime and more consistent service operability related to RPA tools across the organization.

As a further example, the vectorized log data, updated in real-time, may serve as a training or fine-tuning tool for at least one generative AI model, enabling the model to be retrained or fine-tuned over time. For instance, the model could be fine-tuned every three months to enable it to learn from new RPA tools and/or new errors or issues with RPA tools, enabling for greater accuracy in its diagnostic capabilities.

In one example, this disclosure is directed to a system comprising memory and one or more processors in communication with the memory. The one or more processors are configured to stream log data in real-time from a plurality of data storage containers associated with one or more RPA tools; transform in real-time, by one or more embedding models, the log data into vectors for storage in a vector database; receive, via a user interface, a user query that identifies at least one RPA tool of the plurality of RPA tools; perform a search of the vector database based on the user query to obtain a set of vectorized data associated with the at least one RPA tool; generate a prompt based on the user query and the set of vectorized data; generate, by one or more generative AI models, based on the prompt, one or more insights related to the at least one RPA tool; and transmit the one or more insights to a user device for display.

In another example this disclosure is directed to a method comprising streaming log data in real-time from a plurality of data storage containers associated with a plurality of RPA tools; transforming in real-time, by one or more embedding models, the log data into vectors for storage in a vector database; receiving, via a user interface, a user query that identifies at least one of the plurality of RPA tools; performing a search of the vector database based on the user query to obtain a set of vectorized data associated with the at least one of the RPA tool; generating a prompt based on the user query and the set of vectorized data; generating, by one or more generative AI models, based on the prompt, one or more insights related to the at least one RPA tool; and transmitting the one or more insights to a user device for display.

In an additional example this disclosure is directed to non-transitory computer-readable storage media comprising instructions that, when executed, cause one or more processors to stream log data in real-time from a plurality of data storage containers associated with a plurality of RPA tools; transform in real-time, by one or more embedding models, the log data into vectors for storage in a vector database; receive, via a user interface, a user query that identifies at least one RPA tool of the plurality of RPA tools; perform a search of the vector database based on the user query to obtain a set of vectorized data related to the at least one RPA tool; generate a prompt based on the user query and the set of vectorized data; generate, by one or more generative AI models, based on the prompt, one or more insights related to the at least one RPA tool; and transmit the one or more insights to a user device for display.

The details of one or more examples of the disclosure are set forth in the accompanying drawings and the description herein. Other features, objects, and advantages of the disclosure will be apparent from the description and drawings, and from the claims.

### BRIEF DESCRIPTION OF DRAWINGS

FIG. 1 is a block diagram illustrating an example enterprise network including a centralized computing system configured to automatically consolidate log data and provide insights to users based on the log data, in accordance with one or more aspects of this disclosure.

FIG. 2 is a conceptual diagram illustrating example operations of an example computing system, in accordance with one or more aspects of the present disclosure.

FIG. 3 is a block diagram illustrating an example computing system, in accordance with one or more aspects of the present disclosure.

FIG. 4 is a flow diagram illustrating example operations of automatically consolidating log data and providing insights to users based on the log data, in accordance with one or more techniques of this disclosure.

### DETAILED DESCRIPTION

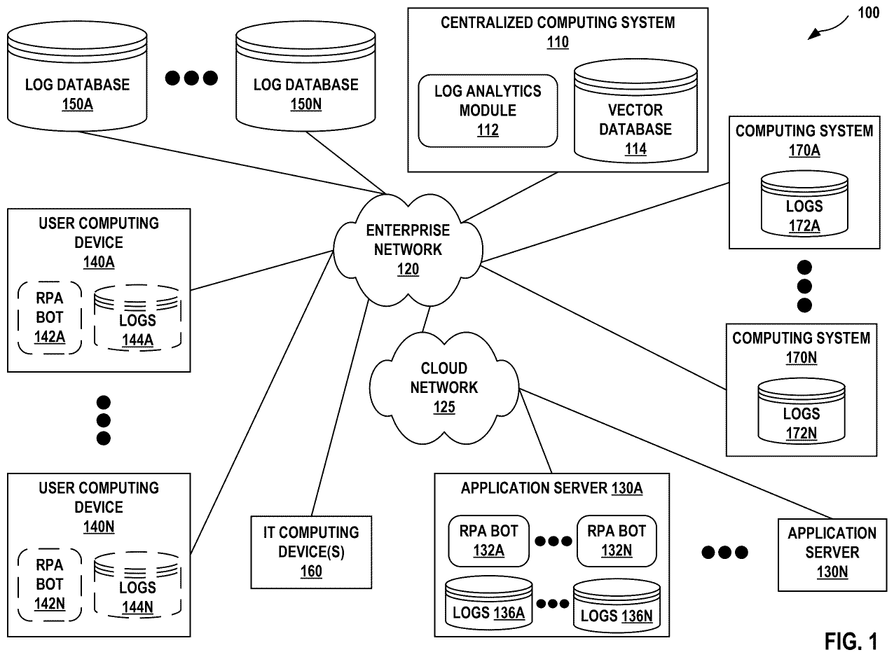

FIG. 1 is a block diagram illustrating an example network system 100 including a centralized computing system 110 configured to automatically consolidate log data associated with one or more RPA tools of an organization and provide insights based on the log data, in accordance with one or more aspects of this disclosure. An RPA tool or “bot” is generally defined as business process automation technology that uses software robots or “bots” to automatically perform tasks according to predefined workflows. In this disclosure, the terms RPA tool and RPA bot are used interchangeably.

Network system 100 includes an enterprise network 120 and a cloud network 125. Enterprise network 120 may be a large-scale enterprise network used or administered by a large organization, such as a financial institution, bank, medical facility, or other type of large organization, which will commonly rely on significant computing resources. For some large organizations, computing and storage resources may be provided through multiple data centers (not shown) deployed within enterprise network 120. Moreover, various applications, services, or other tools used by employees or other users of the organization may be accessible either within enterprise network 120 or from various cloud-based service providers via cloud network 125.

Devices connected to enterprise network 120 may be part of a secure network not normally accessible to the public. Although enterprise network 120 is illustrated as a single network and may be principally located within one location, enterprise network 120 may also comprise multiple networks and be geographically distributed across multiple locations. A number of devices and/or systems are shown connected to enterprise network 120 in FIG. 1. Such devices and systems include centralized computing system 110, user computing devices 140A-140N (collectively, “user devices 140”), log databases 150A-150N (collectively, “standalone log databases 150”), IT computing devices 160, and computing systems 170A-170N (collectively, “computing systems 170”).

Cloud network 125 may be primarily described as a public network, such as the internet. However, techniques in accordance with one or more aspects of the present disclosure may apply to similar systems in which cloud network 125 is implemented as a private network. Cloud network 125 may be used by user devices 140, IT devices 160, and/or centralized computing system 110 within enterprise network 120 to access application servers 130A-130N (collectively, “application servers 130”), which may be hosted by various cloud-based service providers. In some examples, one or more of computing systems 170 may also be hosted by cloud-based service providers and accessible via cloud network 125. In some examples, each of application servers 130 may be located in a geographically disparate location in order to provide high-speed services to user devices 140 and/or components of centralized computing 110 in the same geographic location.

Enterprise network 120 and cloud network 125 illustrated in FIG. 1 may include or represent any public or private communications network or other network. One or more client devices, server devices, or other devices may transmit and receive data, commands, control signals, and/or other information across such networks using any suitable communication techniques. In some examples, Enterprise network 120 and cloud network 125 may be a separate network as illustrated in FIG. 1, or one or more of such networks may be a subnetwork of another network. In other examples, two or more of such networks may be combined into a single network; further, one or more of such networks may be, or may be part of, the internet. Accordingly, one or more of the devices or systems illustrated in FIG. 1 may be in a remote location relative to one or more other illustrated devices or systems. Enterprise network 120 and cloud network 125 illustrated in FIG. 1 may include one or more network hubs, network switches, network routers, network links, satellite dishes, or any other network equipment. Such devices or components may be operatively inter-coupled, thereby providing for the exchange of information between computers, devices, or other components (e.g., between one or more user devices or systems and one or more server devices or systems).

User computing devices 140 may be devices that are used by one or more users of network system 100. User computing devices 140 may represent standard devices that are utilized by one or more employees of the organization. For instance, in one example, user computing device 140A may be a laptop computer utilized by an HR employee of the organization. In another example, user computing device 140B may be a desktop computer utilized by a technician working within the organization. Each of user computing devices 140 may be used to interact with other systems, devices, and components across enterprise network 120 and/or cloud network 125.

Application servers 130, computing devices within each of application servers 130, and/or user devices 140 may each host RPA tools and provide a platform for the execution of various RPA bot services. For ease of illustration, only RPA bots 132 and logs 136A-136N (collectively, “application server log databases 136”) within application server 130A are illustrated in FIG. 1. It should be understood that each of application servers 130B-130N may also execute one or more RPA bots and contain one or more application server log databases.

RPA bots, or tools, may be software tools that are configured to perform well-defined workflows to complete small, tedious, or repetitive tasks. For instance, RPA tools may perform small, mundane tasks, such as copying and pasting information from one area to another, moving files, etc. RPA bots may often be static, rule-based processes, and may face errors when changes are made to one or more components or processes that RPA bots interact with. In some examples, RPA tools may be run manually be one or more users of user computing devices 140. In other examples, RPA tools may be automated and/or scheduled processes configured to run in response to one or more triggers (e.g., a specific time, a specific event, receipt of information or instructions from another computing system, or the like.). For instance, in one example, RPA bot 132A may execute a service on a predefined time schedule (e.g., periodically running every 8 hours). In another example, RPA bot 132B may execute a service once RPA bot 132A has finished executing and has sent a signal to RPA bot 132B to signal the start of performance.

In some examples, RPA tools may be hosted locally on a user computing device (e.g., RPA bots 142A-142N, or, collectively, “local RPA bots 142,” on user computing devices 140). Local RPA bots 142 may be accessible only to the user of the user computing device on which the local RPA bot is hosted (e.g., local RPA bot 142A may only be accessible to users of user computing device 140A). For ease of illustration, only one RPA bot within each of user computing devices 140 is illustrated in FIG. 1. It should be understood that each of user computing devices 140A-140N may contain and execute any number of RPA bots, including zero (i.e., hosting no bots on a device).

Conversely, when application server RPA bots 132A-132N (collectively, “application server RPA bots 132”) are deployed and in use, e.g., within application servers 130, application server RPA bots 132 may be accessible to one or more of user devices 140 that may request that application server bots 132 perform services on their behalf. For instance, in one example, one or more of user devices 140 may interact with application server 130A executing RPA bot 132A within application server 130A. RPA bot 132A may receive one or more indications of input that it determines correspond to input from a user of a user device, e.g., user device 140A. In response to the input, RPA bot 132A causes application server 130A to perform operations and services on behalf of the user of client device 140A. Each of application servers 130 may have any combination of both manually activated (e.g., responsive to user input) or automated types of RPA bots 132. User devices 140 may interact with application servers 130 through enterprise network 120 and cloud network 125.

Each RPA tool may log data related to its execution. For instance, RPA bot 132A may be configured to perform a task on application server 130A. Whenever RPA bot 132A is triggered or otherwise executed by a system or user across network system 100, RPA bot 132A may log data related to the execution (e.g., success metrics, error codes, information related to the trigger mechanism and/or user, etc.). In some examples, an RPA bot may be configured to only log data related to one or more errors encountered while attempting to execute its tasks. In some examples, an RPA tool may log data in one or more local storage nodes. In other examples, an RPA tool may log data in one or more external storage nodes, such as those hosted in cloud network 125 and/or within enterprise network 120.

Application servers 130, computing devices within each of application servers 130, computing systems 170, and computing devices within each of computing systems 170 may host one or more services and processes (not shown) that RPA tools may interact with during their execution. That is, an RPA tool hosted on any of user devices 140 and/or application servers 130 may be configured to interact with computing services that are hosted on any of application servers 130 or computing systems 170. For instance, in one example, RPA bot 142A may be configured to, upon being triggered, send one or more files to computing system 170A, which may run a computing service that backs up received files to the cloud. User devices 140 may interact with computing systems 170 through enterprise network 120.

Each computing service, as well as application servers 130 and/or computing systems 170, may log data related to the execution of one or more services or processes (e.g., success metrics, error cods, information related to the receipt of information and/or one or more execution triggers, etc.). For instance, a cloud storage service may log data related to the file it uploaded, the time of upload, and where it received the uploaded file from. In some examples, a service or process may log data in one or more local storage nodes. In other examples, a service or process may log data in one or more external storage nodes, such as those hosted in the cloud or within enterprise network 120.

Due to the multitude of systems that may host an RPA tool and/or one or more services that an RPA tool may interact with, an individual RPA tool may have logs related to it stored across multiple different systems. Standalone log databases 150, application server databases 136, logs 142A-142N (collectively, “user computing device logs 172”), and logs 172A-172N (collectively, “computing system logs 172”) may represent any suitable data structure or storage medium for storing information related to logs from one or more RPA bots and/or computing services from across network system 100, including systems, devices, or applications included within network system 100. In some examples, data in standalone log databases 150, application server databases 136, user computing device logs 172, and/or computing system logs 172 may represent a system of record associated with an enterprise network 100, which may serve as an authoritative data source for at least some data pertaining to enterprise network 100, or pertaining to the operations of the business, organization, or other entity that administers enterprise network 100. In other examples, data in standalone log databases 150, application server databases 136, user computing device logs 172, and/or computing system logs 172 may represent logs associated with one or more RPA tools. In another example, data in standalone log databases 150, application server databases 136, and/or computing system logs 172 may represent logs associated with one or more computing services, such as an electronic mail server or data storage tool.

In some examples, standalone databases 150, application server databases 136, and computing system logs 172 may be updated and/or maintained by any of user devices 140, application servers 130, and/or computing systems 170.

Any of standalone databases 150, application server databases 136, and computing system logs 172 may include one or more values related to one or more RPA bots from across system 100. In some examples, aspects of application server databases 136 may be included within application servers 130. In other examples, some or all of application server databases 136 may be accessed through a separate system. Similarly, in some examples, aspects of computing system logs 172 may be included within computing systems 170. In other examples, some or all of computing system logs 172 may be accessed through a separate system.

Maintaining and troubleshooting issues for RPA tools is typically a manual, time consuming process due to the large numbers of RPA tools deployed throughout an organization and due to the number of other systems the RPA tools interact with to perform the automated processes. Manually troubleshooting RPA tools across an entire organization may become impossible considering that the organization may have tens of thousands of RPA tools, with logs spread throughout multiple separate systems. For example, in order for a human support agent to manually troubleshoot a single RPA tool, the agent may have to search within multiple logs of multiple systems with different access requirements spread across multiple locations. As such, support teams often use their valuable resources manually reviewing logs, correlating insights, and isolating issues to specific systems to troubleshoot only a small number of critical automations, which may often lead to service level agreement breaches for issue resolution related to other critical automations and long downtimes for less critical automations.

Centralized computing system 110 may interact with application servers log databases 134, user devices log databases 142, computing system logs 172, and standalone databases 150 to consolidate log data from data sources connected to RPA tools within network system 100 and provide analytics related to the RPA tools. Centralized computing system 110 may contain a log analytics module 112 that is responsible for obtaining log data from devices across system 100. Log analytics module 112 may utilize cloud network 125 and/or enterprise network 120 to stream the log data from each of log databases 134, user devices log databases 142, computing system logs 172, and standalone databases 150. Log analytics module 112 may use one or more runtime APIs to interface with the log databases and obtain the log data. in this way, log analytics module 112 may stream the log data continuously, in real-time. Log analytics module 112 may perform a form of pre-processing on the log data to clean or otherwise alter the log data before it is processed by further components or processes of log analytics module 112.

Log analytics module 112 may be configured to use one or more embedding models to covert the log data being streamed into a set of data that may be used by other components of log analytics module 112. The one or more embedding models may be configured to convert words, phrases, symbols, and more in the log data taken in by log analytics module 112 into numerical representations that may be stored as multidimensional vectors. The one or more embedding models may cluster together similar words, phrases, and symbols after being converted into vectors representations. In some examples, this clustering may be done based on at least one attribute related to an identification method for a given RPA bot (e.g., name, unique ID, etc.), a specific error code, or a specific type of automation. For instance, in one example, log analytics module 112 may obtain log data related to storage errors from application server RPA bot 132A and local RPA bot 142A and log data related to network errors from local RPA bot 142B. The one or more embedding models of log analytics module 112 may convert each set of logs into multidimensional vectors for storage in vector database 114. For examples, the vectors related to application server RPA bot 132A and local RPA bot 142A may be clustered together within vector database 114 due to their similar values to one another, while differing from those vectors related to local RPA bot 142B. In this way, the one or more embedding models may be configured to continuously, in real-time, process and convert log data obtained by log analytics modules 112 for storage in vector database 114.

Log analytics module 112 may include components that are configured to take the multidimensional vectors and store them in vector database 114. In some examples, the multidimensional vectors stored in vector database 114 may be organized based on attributes related to one or more RPA bots, such as the name of an RPA bot or a unique identifier. For instance, in one example, vector database 114 may organize the data such that all information related to a specific RPA tool may be grouped together. In some examples, aspects of vector database 114 may be included within centralized computing system 110. In other examples, some or all of application vector database 114 may be accessed through a separate system. The information stored in vector database 114 may be searchable and/or categorized such that one or more modules of centralized computing system 110, such as log analytics module 112, may provide an input requesting information from vector database 114, and in response to the input, receive information stored within vector database 114. In some examples, vector database 114 may be flushed or cleaned periodically to remove excess or outdated error log data, increase storage availability, and/or decrease search times.

Network system 100 may include one or more users that are responsible for diagnosing and repairing computing devices, services, and automations, such as RPA tools, across network system 100 (e.g., internet technology (IT) technician). The one or more technicians may use IT computing devices 160 to access components of network system 100. IT computing devices 160 may have specialized permissions or access that separate them from standard computing devices within the organization (e.g., user computing devices 140). For instance, IT computing devices 160 may have administrative access to access or interact with components of network system 100, such as centralized computing system 110, that are otherwise inaccessible to standard users of network system 100, e.g., user computing devices 140. IT computing devices 160 may be distinguished from other computing devices, e.g., user computing devices 140, through software restrictions, e.g., account credentials, or hardware restrictions, e.g., MAC address filtering. In these examples, user computing devices 140 may be unable to send one or more queries to centralized computing system 110 for information on a respective RPA bot.

IT computing devices 160 may communicate with centralized computing system 110 over enterprise network 120 to query vector database 114. One or more of IT computing devices 160 may input one or more queries related to one or more RPA bots to components of log analytics module 112, such as a user interface. In some examples, the user interface may be a conversational window of a chatbot. The one or more queries may identify one or more specific RPA tools. For instance, a query may include at least one identifier associated with at least one RPA tool, such as a name, ID number, automation type, or an error code.

The one or more user queries may be processed by components of log analytics module 112. For instance, in some examples, log analytics module 112 may use the one or more embedding models to convert the one or more user queries into a set of vectorized data. Log analytics module 112 may use the vectorized data to perform a semantic search on vector database 114. For instance, in one example, a user query may refer to a specific RPA bot, such as by using a unique ID number of local RPA bot 142A. The embedding model may convert the user query to a set of vectors, and log analytics module 112 may use the set of vectors to query vector database 114. The search may return information related to RPA bot 142A.

Based on the results of the query, log analytics module 112 may be configured to generate one or more prompts based on the original query and the results of the query. The one or more prompts may be optimized to be used as the input to one or more generative AI models. The one or more prompts may consist of information related to the one or more user queries and/or the one or more results of the search of vector database 114 (e.g., errors associated with an RPA bot, success information, etc.). For instance, in the scenario of the previous example, log analytics unit 112 may build a prompt for a generative AI model that consists of one or more commands for the generative AI model, such as to diagnose the issues with RPA bot 142A. Log analytics unit 112 may also include information about RPA bot 142A, such as the last ten logs stored by RPA bot 142A in local log database 144A, and connected systems, such as the last ten logs stored by a service that RPA bot 142A interacted with (e.g., a backup system managed by computing system 170A with logs held in computing system log database 172A). As such, the prompt may contain all information necessary for the generative AI model to generate accurate, reliable, and relevant insights.

The one or more prompts may be sent to the one or more generative AI models to generate one or more insights related to at least one of the RPA bots in the user's original query. The one or more generative AI models may be transforming models, such as large-language models (LLMs) that are designed to generate a response to the user based on the input. The one or more insights may relate to diagnostic information for the one or more RPA bots and their associated errors. For instance, in the scenario of the previous example, the generative AI models may determine that the issue relates to the backup system having insufficient storage to receive and store additional files. The models may generate a response detailing the issue and the root cause or diagnosis of the issue. In some examples, the one or more insights may further include information related to potential solutions to fix or resolve the issue associated with the one or more RPA bots. For instance, in the scenario of the previous example, the models may include information in the response that the backup system may need to be provided with additional storage space capabilities, and/or that data currently being stored on the system may need to be purged or removed in order to free up storage space. In some examples, the one or more generative AI models may be fine-tuned on the continually updated log data in vector database 114 to provide the system with up-to-date knowledge of the various RPA bots, their errors, and their respective formatting as such knowledge evolves or changes over time. In some examples, the generative AI models may only be retrained once prior to use in a production environment. In other examples, the generative AI models may be retrained or fine-tuned periodically over the course of its lifetime. For instance, in one example, the generative AI models may be retrained every three months to improve accuracy by providing access to data on new errors or newly activated bots.

Log analytics module 112 may be configured to transmit the one or more insights back to the requesting IT computing device 160 once generated. In some examples, the process of transmitting the one or more insights back to the IT technician may include a graphical user interface (GUI), such as an application, command line tool, or chatbot. For instance, in one example, the GUI could be in the form of an application hosted locally on a computing device or through a third-party application, such as a web browser. In some examples, part of the GUI produced by may include a chatbot or other similar environment where the user may engage in a conversation-style dialog flow with the system. In some examples, the GUI may be the same GUI that a user used to query centralized computing system 110 to begin the processes described herein.

FIG. 1 illustrates only one particular example of network system 100. In the example of FIG. 1, system 100 might include all of the components shown in FIG. 1. However, in other examples, network system 100 may include a subset of the components included and/or may include additional components not shown in FIG. 1. Further, in some examples, one or more user devices 140 in the system 100 may not include RPA bots 142. The optional nature of RPA bots 142 in user devices 140 is indicated through the use of a dashed outline within user devices 140.

Each of the computing systems illustrated in FIG. 1 (e.g., centralized computing system 110, user devices 140, application servers 130, and IT computing devices 160) may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such devices may perform operations described herein as a result of instructions, stored on a computer-readable storage medium, executing on one or more processors. The instructions may be in the form of software stored on one or more local or remote computer readable storage devices. In other examples, one or more of such computing devices may perform operations using hardware, firmware, or a mixture of hardware, software, and firmware residing in and/or executing at each of such computing devices.

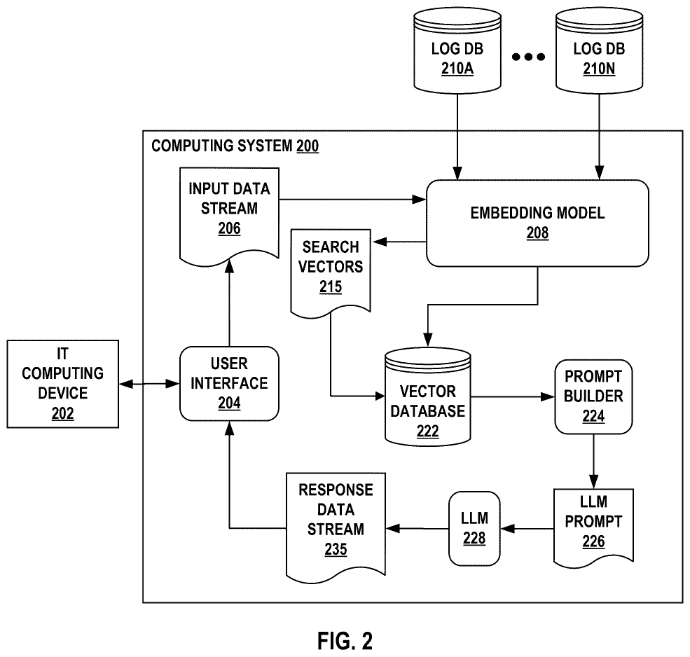

FIG. 2 is a conceptual diagram illustrating an example operation of an example computing system 200, in accordance with one or more aspects of the present disclosure. In the example of FIG. 2, computing system 200 includes an embedding model 208, a prompt builder 224, and a LLM 228 configured to generate one or more insights based on a user query received via a user interface 204 from IT computing device 202. An input data stream 206 may represent the user query and a response data stream 235 may represent the one or more insights generated by LLM 228 that are transmitted back to IT computing device 202 via user interface 204.

Computing system 200 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 200 may comprise a server within a data center, cloud computing system, server farm, and/or server cluster (or portion thereof) that provides services to client devices and other devices or systems. For example, computing system 200 may host or provide access to services provided by vector database 222 and/or one or more LLMs 228 running on computing system 200.

Although computing system 200 of FIG. 2 is illustrated as a stand-alone device, in other examples computing system 200 may be implemented in any of a wide variety of ways and may be implemented using multiple devices and/or systems. In some examples, computing system 200 may be, or may be part of, any component, device, or system that includes a processor or other suitable computing environment for processing information or executing software instructions and that operates in accordance with one or more aspects of the present disclosure. In some examples, computing system 200 may be fully implemented as hardware in one or more devices or logic elements.

Computing system 200 may interact with various log databases across systems and devices connected to computing system 200, such as log databases 210A-210N (collectively, “log databases 210”) to consolidate log data from across an organization. Computing system 200 may utilize various networks, such as cloud networks and/or enterprise networks, to send one or more signals to log databases 210 that may cause log databases 210 to stream log data to computing system 200. Computing system 200 may perform a form of pre-processing on the data to clean or otherwise alter the log data before it is processed further by embedding model 208, Computing system 200 may stream the log data continuously, in real-time.

Embedding model 208 may covert the log data being streamed into a set of data that may be used by other components of computing system 200, such as LLM 228. Embedding model 208 may be configured to convert words, phrases, symbols, and the like from the log data into numerical representations that may be stored as multidimensional vectors in vector database 222. Embedding model 208 may cluster together similar words, phrases, and symbols after being converted into vector representations. In some examples, this clustering may be done based on at least one attribute related to an identification method for a given RPA bot (e.g., name, unique ID, etc.), a specific error code, or a specific type of automation. Embedding model 208 may be configured to continuously, in real-time, process and convert log data.

Computing system 200 may include components that are configured to take the multidimensional vectors generated by embedding model 208 and store them in vector database 222. In some examples, the multidimensional vectors stored in vector database 222 may be organized based on attributes related to one or more RPA bots, such as the name of an RPA bot or a unique identifier. In some examples, aspects of vector database 222 may be included within computing system 200. In other examples, some or all of application vector database 222 may be accessed through a separate system. The information stored in vector database 222 may be searchable and/or categorized such that one or more modules of computing system 200 may query or request information from vector database 222, e.g., by utilizing search vectors 215. In response to the query or request, one or more components of computing device 200, such as prompt builder 224, may receive information responsive to the query or request from vector database 222. In some examples, vector database 222 may be flushed or cleaned periodically to remove excess or outdated error log data, increase storage availability, and/or decrease search times.

As shown in the illustrated example of FIG. 2, a user, such that the user of IT computing device 202, make interact with computing system 200. IT computing device 202 may be any external computing device (e.g., phones, tablets, laptops, personal computers, etc.) sufficient to access, utilize, or otherwise interact with computing system 200 through user interface 204. In some examples, IT computing device 202 may belong to a class of devices which may possess the right to access computing system 200. That is, other devices and/or users in the environment responsible for hosting and/or managing computing system 200 may be unable to interact with the system. IT computing device 202 may be used by one or more IT technicians of the environment in order to perform diagnostics on one or more RPA tools. To perform this task, IT computing device 202 may interact with user interface 204 to query computing system 200 and receive a set of diagnostic insights.

User interface 204 may be a chat bot, communication chat service, communication portal, or other graphical user interface (GUI), such as a browser-based interface or command-line tool. The user interface 204 is connected to the computing system 200 and may be hosted on one or more computing devices on-premises of the organization. While depicted in this example diagram as part of the on-premises computing system 200, the user interface 204 could also be off-premises of the organization (e.g., hosted in the cloud). User interface 204 may enable a user to enter queries for inclusion in input data stream 206 during a communication session. The communication session may include all conversation or chat exchanges that occur while the user is logged into an account and/or user interface 204. The communication session may end when the user logs off or otherwise becomes disconnected from the account and/or user interface 204.

Input data steam 206 may comprise text data, voice data, or image data. Computing system 200 is configured to process and accurately answer queries within input data stream 206 using components of computing system 200, such as embedding model 208, prompt builder 224, and LLM 228. More specifically, embedding model 208 receives input data stream 206. Embedding model may transform the query into search vectors 215, which may further be passed to vector database 222. In some examples, one or more components of computing system 200, such as user interface 204, may pre-process input data stream 206 to prepare input data stream 206 for processing by embedding model 208. In the case where input data stream 206 comprises voice data or image data, user interface 204 may contain or otherwise work with components that may convert the voice data or image data into text data prior to passing input data stream 206 to embedding model 208. Input data stream 206 includes one or more user queries related to one or more RPA bots, The one or more user queries may identify one or more specific RPA tools. For instance, a user query may include at least one identifier associated with the at least one RPA tool, such as a name, ID number, automation type, or an error code.

Embedding model 208 may convert the one or more user queries into search vectors 215. Embedding model 208 may perform the same process as was performed on log data from log databases 210 to convert the user query in input data stream 206 to a series of numerical representations stored in multidimensional vectors (e.g., search vectors 215). Search vectors 215 may be used, alongside other components of computing system 200 (not shown) to perform a semantic search on vector database 222. A semantic search may involve, in part, measuring the distance between various points in vector database 222 and search vectors 215 to locate a set of vectorized log data that is related to the user query in input data stream 206. For instance, in one example, a user query may refer to a specific RPA bot, such as by using a unique identification number. Embedding model 208 may convert the user query of input data stream 206 into search vectors 215, and computing system 200 may use search vectors 215 to query vector database 222 and search for relevant information to search vectors 215 (e.g.,. vector data within a certain distance of search vectors 215). The search may return information, stored as a set of vectors, related to the queried RPA tool.

The results of the search of vector database 222 may be sent to prompt builder 224. Based on the results of the query, prompt builder 224 may be configured to generate a prompt (e.g., LLM prompt 226) based on the original user query (e.g., input data stream 206) and the results of the query from vector database 222. LLM prompt 226 may be optimized to be used as the input to one or more generative AI models, e.g., LLM 228, and may include information obtained from vector database 222, such as errors associated with the queried RPA bot, success information, and so on. For instance, in the scenario of the previous example, prompt builder 224 may build LLM prompt 226 to consist of one or more commands for LLM 228, such as to diagnose the issues with the specific RPA bot. Prompt builder 224 may include information about the RPA bot, such as the last ten logs stored by the RPA bot that prompt builder 224 received from the search of vector database 222. As such, LLM prompt 226 may contain all information necessary for LLM 228 to generate accurate, reliable, and relevant insights related to the specific RPA bot.

Prompt builder 224 may send LLM prompt 226 to LLM 228 to generate one or more insights related to at least one of the RPA bots in the user's original query. LLM 228 may generate a response to at least one of the user queries within input data stream 206 based on the search results from vector database 222 and the original user query in input data stream 206. The response generated by LLM 228 may contain one or more insights as to what errors are currently impacting the one or more RPA tools specified by the user in the user query in input data stream 206. In some examples, the response generated by LLM 228 may further include information related to at least one root cause of the errors and/or one or more potential solutions to fix the one or more errors associated with the one or more RPA bots queried in input data stream 206.

In some examples, LLM 228 may be fine-tuned on the continually updated log data in vector database 222 to provide the model with up-to-date knowledge of the various RPA bots, their errors, and their respective formatting as such knowledge evolves or changes over time. In some examples, LLM 228 may only be retrained once prior to use in a production environment. In other examples, LLM 228 may be retrained or fine-tuned periodically over the course of its lifetime. For instance, in one example, LLM 228 may be retrained every three months to improve accuracy by providing access to data on new errors or newly activated bots.

In some examples, LLM 228 may perform the response building on-premises of the organization. In other examples, LLM 228 may be hosted on one or more remote systems, and therefore may perform the response building off-premises of the organization. LLM 228 may send response data stream 235 including one or more generated responses back to user interface 204, which then provides the responses to the user of IT computing device 202.

FIG. 2 illustrates only one particular example of network system 100. In the example of FIG. 2, computing system 200 might include all of the components shown in FIG. 2. However, in other examples, computing system 200 may include a subset of the components included and/or may include additional components not shown in FIG. 2.

Computing system 200, as is illustrated in FIG. 2, may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such devices may perform operations described herein as a result of instructions, stored on a computer-readable storage medium, executing on one or more processors. The instructions may be in the form of software stored on one or more local or remote computer readable storage devices. In other examples, one or more of such computing devices may perform operations using hardware, firmware, or a mixture of hardware, software, and firmware residing in and/or executing at each of such computing devices.

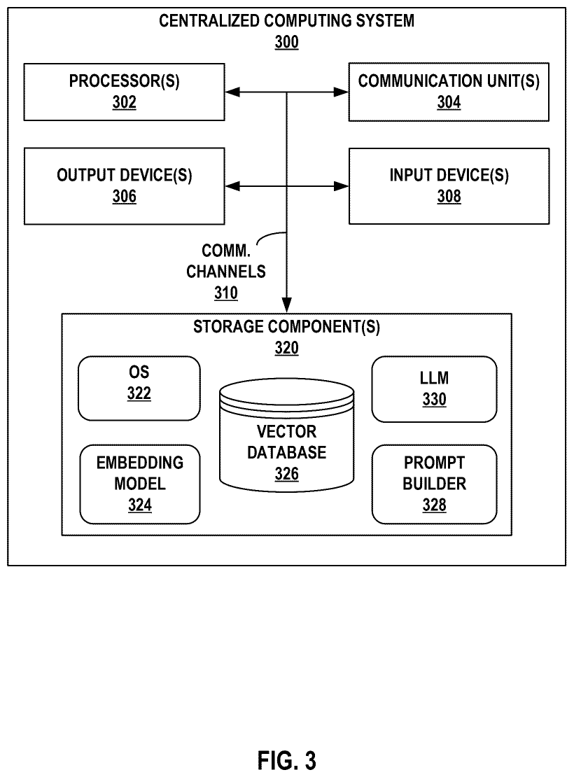

FIG. 3 is a block diagram illustrating an example computing system 300, in accordance with one or more aspects of the present disclosure. Computing system 300 may generally correspond to the centralized computing system 110 of FIG. 1 and/or computing system 200 of FIG. 2. Accordingly, embedding model 324, prompt builder 328, and LLM 330 may perform some or all of the same functions described as being performed by log analytics units 112 from FIG. 1 and/or embedding model 208, prompt builder 224, and LLM 228, respectively, from FIG. 2. Similarly, vector database 326 may perform some or all of the same functions described as being performed by vector database 114 from FIG. 1 and/or vector database 222 from FIG. 2.

Computing system 300 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 300 may comprise a server within a data center, cloud computing system, server farm, and/or server cluster (or portion thereof) that provides services to client devices and other devices or systems. For example, computing device 300 may host or provide access to services provided by vector database 326 and/or one or more LLMs 330 running on computing device 300.

Although computing device 300 of FIG. 3 is illustrated as a stand-alone device, in other examples computing device 300 may be implemented in any of a wide variety of ways and may be implemented using multiple devices and/or systems. In some examples, computing device 300 may be, or may be part of, any component, device, or system that includes a processor or other suitable computing environment for processing information or executing software instructions and that operates in accordance with one or more aspects of the present disclosure. In some examples, computing device 300 may be fully implemented as hardware in one or more devices or logic elements.

In the example of FIG. 3, computing device 300 may include one or more processors 302, one or more communication units 304, one or more output components 306, one or more input components 308, one or more communication channels 310, and one or more storage components 320. in the illustrated example, storage components 320 include operating system (OS) 322, embedding model 324 to process log data and store the vectors, vector database 326 for storing the vectors, prompt builder 328 for creating a prompt, and LLM 330 for processing the prompt and generating one or more insights. One or more of the devices, modules, storage areas, or other components of computing device 300 may be interconnected to enable inter-component communications (physically, communicatively, and/or operatively).

Communication channels 310 may interconnect each of the components 302, 304, 306, 308, and/or 320 for inter-component communications (physically, communicatively, and/or operatively). In some examples, communication channels 310 may include a system bus, a network connection, an inter-process communication data structure, or any other method for communicating data.

A power source (not shown) provides power to one or more components of computing device 300. In some examples, the power source may receive power from the primary alternative current (AC) power supply in a commercial building or data center, where some or all of an enterprise network may reside. In other examples, the power source may be or may include a battery.

One or more processors 302 of computing device 300 may implement functionality and/or execute instructions associated with computing device 300 associated with one or more modules illustrated herein and/or described below. One or more processors 302 may be, may be part of, and/or may include processing circuitry that performs operations in accordance with one or more aspects of the present disclosure. Examples of processors 302 include microprocessors, application processors, display controllers, auxiliary processors, one or more sensor hubs, and any other hardware configured to function as a processor, a processing unit, or a processing device. Computing device 300 may use one or more processors 302 to perform operations in accordance with one or more aspects of the present disclosure using software, hardware, firmware, or a mixture of hardware, software, and firmware residing in and/or executing at computing device 300.

One or more communication units 304 of computing device 300 may communicate with devices external to computing device 300 by transmitting and/or receiving data, and may operate, in some respects, as both an input device and an output device. In some examples, communication units 304 may communicate with other devices over a network. In other examples, communication units 304 may send and/or receive radio signals on a radio network such as a cellular radio network. In other examples, communication units 304 of computing device 300 may transmit and/or receive satellite signals on a satellite network such as a Global Positioning System (GPS) network. Examples of communication units 304 include a network interface card (e.g., such as an Ethernet card), an optical transceiver, a radio frequency transceiver, a GPS receiver, or any other type of device that may send and/or receive information. Other examples of communication units 304 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 308 may represent any input devices of computing system 300 not otherwise separately described herein. One or more input devices 308 may generate, receive, and/or process input from any type of device capable of detecting input from a human or machine. For example, one or more input devices 308 may generate, receive, and/or process input in the form of electrical, physical, audio, image, and/or visual input (e.g., peripheral device, keyboard, microphone, camera). For computing devices that may be used by a user, one or more input devices 308 may generate or receive input from a keyboard, pointing device, voice responsive system, video camera, button, sensor, mobile input device, control pad, microphone, presence-sensitive screen, network, or any other type of device for detecting input from a human or machine.

One or more output devices 306 may represent any output devices of computing system 300 not otherwise separately described herein. One or more output devices 306 may generate, receive, and/or process input from any type of device capable of detecting input from a human or machine. For example, one or more output devices 306 may generate, receive, and/or process output in the form of electrical and/or physical output (e.g., peripheral device, actuator). For computing devices that may be used by a user, one or more output devices 306 may generate, present, and/or process output in the form of tactile, audio, visual, video, and other output. Some devices may serve as both input and output devices. For example, a communication device may both send and receive data to and from other systems or devices over a network.

One or more storage components 320 within computing device 300 may store information for processing during operation of computing device 300. Storage components 320 may include one or more types of storage such as hard disk drives, solid state drives (e.g., SATA drives, NVMe drives, eMMC storage, etc.), magnetic tape drives, remote storage (e.g., cloud storage), and/or other types of storage. Storage components 320 may store program instructions and/or data associated with one or more of the modules described in accordance with one or more aspects of this disclosure. One or more processors 302 and one or more storage components 320 may provide an operating environment or platform for such modules, which may be implemented as software, but may in some examples include any combination of hardware, firmware, and software. One or more processors 302 may execute instructions and one or more storage components 320 may store instructions and/or data of one or more modules. The combination of processors 302 and storage components 320 may retrieve, store, and/or execute the instructions and/or data of one or more applications, modules, or software. Processors 302 and/or storage components 320 may also be operably coupled to one or more other software and/or hardware components, including, but not limited to, one or more of the components of computing device 300 and/or one or more devices or systems illustrated as being connected to computing device 300.

In some examples, one or more storage components 320 are temporary memories, meaning that a primary purpose of the one or more storage components is not long-term storage. Storage components 320 of application computing device 300 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Storage components 320, in some examples, also include one or more computer-readable storage media. Storage components 320 may be configured to store larger amounts of information than volatile memory. Storage components 320 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

Storage components 320, as illustrated in FIG. 3, includes OS 322, embedding model 324, vector database 326, prompt builder 328, and LLM 330. Operating system 322 may perform foundational functions capable of being invoked by various modules executing on centralized computing device 300. In some examples, operating system 322 may include a user interface service library that may perform functions relating to presenting audio, visual, or other information, such as through audio devices, display screens, haptic feedback devices, or otherwise. Operating system 322 may also act as an interface for receiving input from a user, through touch interactions, voice commands, or otherwise. Further, operating system 322 may provide token processing and/or token abstraction services that may be accessed by and/or leveraged by modules and/or applications executing on system 300.

Embedding model 324 may be configured to continuously and in real-time obtain data from one or more external log databases, such as standalone log database 150A or local log database 144A in FIG. 1. The one or more external log databases may be hosted on-premises or off-premises, with respect to centralized computing system 300. Embedding model 324 may be a recurrent neural network (RNNs) and/or transformer models (self-attention models), such as GPT-3, BERT, and T5. Embedding model 324 may be configured to convert the log data it receives from the one or more log databases into a series of vectors numerical representations that may be stored as multidimensional vectors, where each value represents a different dimension. In some examples, embedding model 324 may engage in dimensionality reduction to determine the optimal balance model speed and efficiency and accuracy and precision. Embedding model 324 may reduce vector size through processes such as principal component analysis, T-distributed stochastic neighbor embedding (t-SNE), or through the usage of convolutional neural networks as opposed to standard RNNs.

In some examples, embedding model 324 may use one or more forms of semantic analysis when preforming the embedding process, such as latent semantic analysis (LSA) or latent Dirichlet allocation (LDA). The multidimensional vectors may have no set of dimensional ranges (i.e., values). For instance, in some examples, embedding model 324 may generate vectors with five hundred dimensions. In another example, embedding model 324 may generate vectors with five thousand dimensions. The embedding model may continuously update the embedding mappings over a period of time. Similarly, the embedding model may alter the dimensions of the of the multidimensional vectors over a period of time.

Embedding model 324 may cluster together similar words, phrases, and symbols after being converted into vectors representations. In some examples, this clustering may be done based on at least one attribute related to an identification method for a given RPA bot (i.e., name, unique ID, etc.), a specific error code, and/or a specific type of automation. For instance, in one example, embedding model 324 may obtain log data related to storage errors from multiple RPA tools from across the system to which centralized computing system 300 is connected. Embedding model 324 may receive, from the same system, log data related to network errors from one or more separate RPA tools. Embedding model 324 of log analytics module 112 may convert each set of logs into multidimensional vectors. The vectors related to the storage errors may be clustered together due to their similar values to one another, while differing from those vectors related to the network errors. For instance, in an example where embedding model 324 generates only two-dimensional vectors, the storage error logs may be given vector values of {20, 50} and {25, 48}, respectively, while the network error logs may be given a vector value of {200, 140}.

Determining the relationship between two data points (e.g., how similar the embedding model believes them to be) may be performed by measuring the distance from corresponding points in various vectors using techniques such as measuring Euclidean distance or cosine distance. For instance, in the previous example, where embedding model 324 generated only two-dimensional vectors, the two storage-related log vectors have a Euclidean distance of 5.39 from each other. However, each storage-related log vector has a Euclidean distance of more than 195 from the network-related log vector. As such, embedding model 324 may indicate that the two vectors related to the storage logs are more similar to each other than either set of vectors are to the vector related to the network logs.

In some examples, embedding model 324, alongside other components of centralized computing system 300, may normalize the vectors to emphasize vector weights and reduce the impact of high magnitude differences. For instance, embedding model 324 may perform a series of alterations on the vectors based on the number of dimensions in each vector and/or the number of items represented by the vectors. As one example, the embedding model may have the set of vectors {10, 1}, {1, 10}, and {200, 1}. Using magnitude alone to calculate the distance, it may be determined that {10, 1} and {1, 10} are more like one another, even though {10, 1} may actually have more in common with {200, 1}, since both possess high values for the factor the first dimension is measuring. Embedding model 324 may normalize the vectors to ensure that {10, 1} and {200, 1} are closer than {10, 1} and {1, 10}.

Embedding model 324 may primarily maintain vector database 326 of centralized computing system 300. Vector database 326 may represent any suitable data structure or storage medium for storing information relating to vectors generated by embedding model 324. The vectors stored in vector database 326 may be searchable and/or categorized such that one or more modules within centralized computing system 300, and/or one or more external computing devices, may provide an input requesting information from vector database 326. In response to the input, the modules and/or computing devices may receive the information stored within vector database 326. In some examples, the multidimensional vectors stored in vector database 326 may be organized based on attributes related to one or more RPA bots, such as the name of an RPA bot or a unique identifier. In some examples, aspects of vector database 326 may be included within centralized computing system 300. In other examples, some or all of application vector database 326 may be accessed through a separate system. In some examples, vector database 326 may be flushed or cleaned periodically to remove excess or outdated log data, increase storage availability, and/or decrease search times.

Centralized computing system 300 may, at times, receive requests from external computing devices and systems for insights regarding one or more RPA tools connected to the same system in which centralized computing system 300 operates. For instance, an IT technician, such as a user of IT computing device 160 in FIG. 1, may request diagnostic information on one or more RPA tools. OS 322 may create and/or manage one or more user interfaces that may enable connected users to interact with and otherwise access centralized computing system 300. The user interface may interact with external users by using one or more of communication units 304 and output components 306/input components 308 to create a communication session with an external user. The communication session may begin upon the user connecting to the user interface, such as through the use of an online service or portal. The communication session may include all conversation or chat exchanges that occur while the user is connected to the user interface. The communication session may end when the user logs off or otherwise becomes disconnected from the user interface.

For instance, in some examples, OS 322 may create and manage a chatbot that operates as a form of software to enable the user to engage in a conversation. The chatbot, or user interface in general, may take in textual input from the user and provide a response based at least in part on the user input. The chatbot may be implemented using a combination of standard rules (i.e., a decision tree), sentiment analysis, and various artificial intelligence techniques. In some examples, the chatbot may be one single entity, or in other examples, may be made up of several children systems that may be used to enable a variety of techniques, such as enabling the chatbot to interact with multiple users concurrently, or to speed up query processing by splitting queries and performing analysis on various subparts concurrently.

OS 322 may obtain the user query from the communication session and perform vectorization on the query using embedding model 324. Embedding model 324 may convert the user query into a series of search vectors. Embedding model 324 may perform the same process as was performed on logs stored in vector database 326 to convert the user query to a series of numerical representations stored in multidimensional vectors for search. The search vectors may be used, alongside other components of centralized computing system 300, to perform a semantic search on vector database 326. A semantic search may involve, in part, measuring the distance between various points in vector database 326 and the set of search vectors to locate a set of vectorized log data that is related to the user query. The search may return information, stored as a set of vectors, related to the queried RPA tool. For instance, returning to the above example, a user may query for information related to a specific RPA that performs a storage-related task. Embedding model 324 may transform the user query into the set of vectors of {30, 40}. The search may return nearby logs that may contain information relevant to the same task, error, or bot, such as the vectors {20, 50} and {25, 48}. The search process may also involve standard search techniques, such as searching a specific aspect of vector database 326, where only information related to a specific RPA tool may be located.

The results of the search of vector database 326 may be sent to prompt builder 328. Prompt builder 328 may be a type of transforming model such as Generative Pre-trained Transformer (GPT), Claude, BigScience Large Open-science Open-access Multilingual Language Model (BLOOM), Large Language Model Meta AI (LLaMA), Mistral 7B, or any other similar model known in the art. Prompt builder 328 may be configured to generate a prompt based on the original user query and the results of the query of vector database 326. As such, prompt builder 328 may include information from the search of vector database 326, such as errors associated with the queried RPA bot, success information, and so on. For instance, in the scenario of the previous example, prompt builder 328 may build an LLM prompt that consists of one or more commands for a generative AI model (e.g., LLM 330), such as to diagnose the issues with specific RPA bot. Prompt builder 328 may include information about the RPA bot, such as the last ten logs stored by the RPA bot that prompt builder 328 received from the search of vector database 326. As such, the LLM prompt may contain all information necessary for the generative AI models to generate accurate, reliable, and relevant insights with respect to an identified RPA bot. Prompt builder 328 may send the LLM prompt to LLM 330 to generate one or more insights related to the RPA bot in the user query.

LLM 330 is configured to generate a response to at least one of the user queries within the communication session and transmit the response back to the user. LLM 330 may be a pre-trained model based on historical error log data contained within the vector database 326. The response generated by LLM 330 may contain one or more insights as to what errors are currently impacting the RPA bot specified by the user in the user query in the communications session. In some examples, the response generated by LLM 330 may further include information related to at least one root cause of the errors associated with the RPA bot and/or one or more potential solutions to fix the errors associated with the RPA bot identified in the communication session.

In some examples, LLM 330 may be re-trained or fine-tuned in conjunction with the continuously updated vector database 326 to maintain high accuracy levels. For example, when vector database 326 receives new error codes not previously analyzed by LLM 330, the model may be re-trained to gain a greater understanding of the new error codes. In some examples, LLM 330 may only be retrained once prior to use in a production environment. In other examples, LLM 330 may be retrained or fine-tuned periodically over the course of its lifetime. For instance, in one example, LLM 228 may be retrained every three months to improve accuracy by providing access to data on new errors or newly activated bots.

In the example of FIG. 3, LLM 330 may be a type of model such as GPT, Claude, BLOOM, LLaMA, Mistral 7B, or any other similar model known in the art. While illustrated in FIG. 3 as an LLM, in other examples, LLM 330 may be another type of question-answering transformer models. such as Bidirectional Encoder Representations from Transformers (BERT), Robustly Optimized BERT Pretraining Approach (RoBERTa), Text-To-Text Transfer Transformer (T5), or any other similar model known in the art.

FIG. 3 illustrates only one particular example of centralized computing system 300. In the example of FIG. 3, centralized computing system 300 might include all of the components shown in FIG. 3. However, in other examples, centralized computing system 300 may include a subset of the components included or may include additional components not shown in FIG. 3.

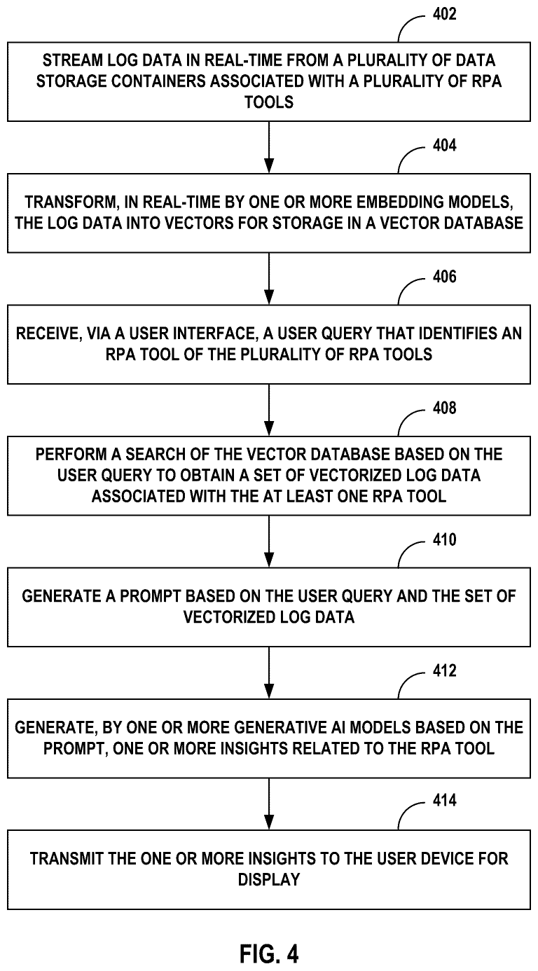

FIG. 4 is a flow diagram illustrating example operations of automatically consolidating log data and providing insights to users based on the log data, in accordance with one or more aspects of the present disclosure. FIG. 4 is described below within the context of centralized computing system 300 of FIG. 3. In other examples, operations described in FIG. 4 may be performed by one or more other components, modules, systems, or devices. Further, in other examples, operations described in connection with FIG. 4 may be merged, performed in a difference sequence, omitted, or may encompass additional operations not specifically illustrated or described.

In the process illustrated in FIG. 4, and in accordance with one or more aspects of the present disclosure, computing system 300 streams log data in real-time from a plurality of data storage containers, e.g., logs, associated with a plurality of RPA tools (402). For example, operating system 322 of centralized computing system 300 may cause components of computing system 300 to interact with connected log databases and stream log data from each database. Centralized computing system 300 interacts with log databases, such as standalone log databases 150, local log databases 144, application server log databases 134, and/or computing system log databases 172 from FIG. 1, and obtains a continuous stream of log data in real-time. More specifically, to stream the log data in real-time, centralized computing system 300 streams RPA log data from logs generated by each RPA tool of the plurality of RPA tools, e.g., RPA log databases 136, 144 of RPA bots 132, 142, respectively, and streams system log data from logs generated by each system of a plurality of disparate systems instructed to perform operations by the plurality of RPA tools, e.g., log databases 172 of computing systems 170.

Centralized computing system 300 transforms, in real-time, the log data into vectors for storage in vector database 326 (404). Embedding model 324 may be configured to continuously update vector database 326 based on the real-time streaming and transformation of the log data. In some scenarios, centralized computing system 300 may fine-tune one or more generative AI models, e.g., LLM 330, based on the continuously updated vector database 326. For example, centralized computing system 300 may use embedding model 324 to transform the log data that obtained in real-time. Embedding model 324 may transform the logs into numerical representations that may be stored in multidimensional vectors. where each value represents a different dimension. Embedding model 324 cluster together similar words, phrases, and symbols after being converted into vectors representations. In some examples, this clustering may be done based on at least one attribute related to an identification method for a given RPA bot. For example, the one or more attributes may include a name or an identifier of the at least one RPA tool for which the log data was generated, by the at least one RPA tool itself and by one or more disparate systems instructed to perform operations by the at least one RPA tool. The RPA tool may be identified by one or more of a name, an identifier, e.g., a unique ID number, a specific error code, and/or a specific type of automation.

Embedding model 324 may store the converted vectors in one or more databases, such as vector database 326. More specifically, embedding model 324 may be configured to store the vectors of the log data in vector database 326 organized by one or more attributes of the log data and/or according to the clustering performed by embedding model 324. Vector database 326 may represent any suitable data structure or storage medium for storing information relating to vectors generated by embedding model 324. The vectors stored in vector database 326 may be searchable and/or categorized such that one or more modules within centralized computing system 300, and/or one or more external computing devices, may provide an input requesting information from vector database 326. In response to the input, the modules and/or computing devices may receive the information stored within vector database 326.

Centralized computing system 300 receives a user query that identifies an RPA tool of the plurality of RPA tools (406). For example, centralized computing system 300 may utilize various components, such as OS 322, to create a user interface, such as communication chat service, communication portal, browser-based interface, or command-line tool. In some examples, the user interface may comprise a conversation window of a chatbot. The user interface can accept queries from one or more users across the system that are permitted to access centralized computing system 300 (e.g., IT computing devices 160 of FIG. 1). The queries may be related to one or more specific RPA tools or related services from across the organization.

In response to receiving a user query, centralized computing system 300 performs a search of vector database 326 based on the user query to obtain a set of vectorized log data associated with the RPA tool identified in the user query (408). Centralized computing system 300 may transform the user query into a series of vectors using embedding model 324 and performs a semantic search on vector database 326 using the series of vectors of the user query.

Centralized computing system 300 generates a prompt based on the user query and the set of vectorized log data (410). For example, centralized computing system 300 may use a generative AI model, such as prompt builder 328, to create a prompt based on the results of the search of vector database 326 combined with the original user query. The prompt may contain information relevant to the user query, such as the questions or logs and/or RPA-related services identified in the user query. More specifically, to generate the prompt, prompt builder 328 may transform the set of vectorized log data of the search results from vector database 326 into text of log data associated with the RPA tool, including log data generated by the RPA tool itself and by one or more disparate systems instructed to perform operations by the at least one RPA tool. Prompt builder 326 may then build the prompt requesting the one or more insights related to the RPA tool based on the user query and the text of the log data associated with the at least one RPA tool.

Centralized computing system 300 uses another generative AI model, such as LLM 330, to generate, based on the prompt, one or more insights related to the RPA tool identified in the user query (412). In some examples, the generative AI models may comprise one or more question-answering transformer models. In examples where the generative AI models comprise one or LLMs, e.g., LLM 330, the LLMs may be configured to generate one or more natural language insights related to the RPA tool. For example, centralized computing system 300 may use LLM 330 to generate one or more insights related to one or more components of the user query, based on the prompt received from prompt builder 328. LLM 330 may generate diagnostic insights, such as those that provide details on why one or more queried tools, bots, systems, or processes are encountering errors. In some examples, LLM 330 may also generate solution-based insights, such as those that provide at least one root cause of the errors and/or one or more potential solutions to fix or resolve the one or more errors associated with the queried tools, bots, systems, or processes.

Centralized computing system 300 may transmit the one or more insights to a user device, e.g., one or IT computing devices 160 of FIG. 1, of the user for display (414). For example, centralized computing system 300 may use the user interface previously generated by OS 322 to transmit the one or more insights generated by LLM 330 back to the user. In the case where the user interface comprises a conversation window of a chatbot, centralized computing system 300 may transmit data representative of a conversation response that includes the one or more insights for display in the conversation window of the chatbot. The user, such as an IT technician using IT computing device 160, may use the one or more insights to diagnose and/or resolve errors across the organization's computing environment, such as RPA tools or computing processes and services.

For processes, apparatuses, and other examples or illustrations described herein, including in any flowcharts or flow diagrams, certain operations, acts, steps, or events included in any of the techniques described herein may be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, a limited number of devices or systems are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of computer programs from one place to another, e.g., according to a communication protocol. In this manner, computer-readable storage media generally may correspond to (1) tangible computer-readable storage media which is non-transitory or (2) a communication media such as signal or carrier wave. Data storage media may be any available media that may be accessed by one or more computers or one or more processing circuits to receive instructs, code and/or data structures for implementation of the techniques described in this disclosure. A computer program product may include a computer-readable medium.

By way of example and not limitation, such computer-readable storage media may include RAM, ROM, EEPROM, CD-ROM, or other optical disk storage, magnetic disk storage, or other magnetic storage devices, flash memory, cache memory, or any other medium that may be used to store desired program code in the form of instructions or store data structures and that may be access by a computer. Also, any connection is a properly termed a computer-readable medium. For example, if instructions are transmitted from a website, server, or other remote source using a coaxial cable, fiber optic cable, twisted pair, digital subscriber line (DSL), or other wireless technologies such as infrared, radio, and microwave, then the coaxial cable, fiber optic cable, twisted pair, DSL, or other wireless technologies such as infrared, radio, and microwave are included in the definition of medium. It should be understood, however, that computer readable storage media and data storage media do not include connections, carrier waves, signals, or other transient media, but are directed to non-transient, tangible storage media. Disk and disc, as used herein, includes compact disk (CD), laser disc, optical disc, digital versatile disc (DVD), and Blu-ray disc, where disks usually reproduce data magnetically, while discs reproduce data optically with lasers. Combinations of the above should be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor”, as used herein may refer to any of the foregoing structure of any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, software systems, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A system comprising:
memory; and
one or more processors in communication with the memory and configured to:
stream log data in real-time from a plurality of data storage containers associated with a plurality of robotic process automation (RPA) tools;
transform in real-time, by one or more embedding models, the log data into vectors for storage in a vector database;
receive, via a user interface, a user query that identifies at least one RPA tool of the plurality of RPA tools;
perform a search of the vector database based on the user query to obtain a set of vectorized log data associated with the at least one RPA tool;
generate a prompt based on the user query and the set of vectorized log data;
generate, by one or more generative artificial intelligence (AI) models based on the prompt, one or more insights related to the at least one RPA tool; and
transmit the one or more insights to a user device for display.

2. The system of claim 1, wherein the one or more processors are configured to continuously update the vector database based on the real-time streaming and transformation of the log data.

3. The system of claim 2, wherein the one or more processors are further configured to fine-tune the one or more generative AI models based on the continuously updated vector database.

4. The system of claim 1, wherein to stream the log data in real-time, the one or more processors are configured to:
stream RPA log data from logs generated by each RPA tool of the plurality of RPA tools; and stream system log data from logs generated by each system of a plurality of disparate systems instructed to perform operations by the plurality of RPA tools.

5. The system of claim 1, wherein the one or more processors are configured to store the vectors of the log data in the vector database organized by one or more attributes of the log data.

6. The system of claim 5, wherein the one or more attributes of the log data include a name or an identifier of the at least one RPA tool for which the log data was generated by the at least one RPA tool itself and by one or more disparate systems instructed to perform operations by the at least one RPA tool.

7. The system of claim 1, wherein to perform the search of the vector database, the one or more processors are configured to:
transform, by the one or more embedding models, the user query to a series of vectors; and
perform a semantic search on the vector database using the series of vectors of the user query.

8. The system of claim 1, wherein to generate the prompt, the one or more processors are configured to:
transform the set of vectorized log data into text of log data associated with the at least one RPA tool, including log data generated by the at least one RPA tool itself and by one or more disparate systems instructed to perform operations by the at least one RPA tool; and
build the prompt requesting the one or more insights related to the at least one RPA tool based on the user query and the text of the log data associated with the at least one RPA tool.

9. The system of claim 1, wherein the one or more insights generated by the one or more generative AI models comprise at least one of: one or more issues related to the at least one RPA tool identified in the user query, at least one root cause of the one or more issues, or one or more predicted solutions to resolve the one or more issues.

10. The system of claim 1, wherein to identify the at least one RPA tool, the user query includes at least one of a name, an identifier, an automation type, or an error code associated with the at least one RPA tool.

11. The system of claim 1, wherein the one or more generative AI models comprise one or more question-answering transformer models.

12. The system of claim 1, wherein the one or more generative AI models comprise one or more large-language models (LLMs), and wherein to generate the one or more insights, the one or LLMs are configured to generate one or more natural language insights related to the at least one RPA tool.

13. The system of claim 1, wherein the user interface comprises a conversation window of a chatbot, and wherein to transmit the one or more insights to the user device, the one or more processors are configured to transmit data representative of a conversation response that includes the one or more insights for display in the conversation window of the chatbot.

14. A method comprising:
streaming log data in real-time from a plurality of data storage containers associated with a plurality of robotic process automation (RPA) tools;
transforming in real-time, by one or more embedding models, the log data into vectors for storage in a vector database;
receiving, via a user interface, a user query that identifies at least one RPA tool of the plurality of RPA tools;
performing a search of the vector database based on the user query to obtain a set of vectorized log data associated with the at least one RPA tool;
generating a prompt based on the user query and the set of vectorized log data;
generating, by one or more generative AI models, based on the prompt, one or more insights related to the at least one RPA tool; and
transmitting the one or more insights to a user device for display.

15. The method of claim 14, further comprising continuously updating the vector database based on the real-time streaming and transforming of the log data.

16. The method of claim 14, wherein streaming the log data in real-time includes:
streaming RPA log data from logs generated by each RPA tool of the plurality of RPA tools; and
streaming system log data from logs generated by each system of a plurality of disparate systems instructed to perform operations by the plurality of RPA tools.

17. The method of claim 14, wherein performing the search of the vector database includes:
transforming, by the one or more embedding models, the user query to a series of vectors; and
performing a semantic search on the vector database using the series of vectors of the user query.

18. The method of claim 14, wherein generating the prompt includes:
transforming the set of vectorized log data into text of log data associated with the at least one RPA tool, including log data generated by the at least one RPA tool itself and by one or more disparate systems instructed to perform operations by the at least one RPA tool; and
building the prompt requesting the one or more insights related to the at least one RPA tool based on the user query and the text of the log data associated with the at least one RPA tool.

19. The method of claim 14, wherein the one or more insights generated by the one or more generative AI models comprise at least one of: one or more issues related to the at least one RPA tool identified in the user query, at least one root cause of the one or more issues, or one or more predicted solutions to resolve the one or more issues.

20. Non-transitory computer-readable storage media comprising instructions that, when executed, cause one or more processors to:
stream log data in real-time from a plurality of data storage containers associated with a plurality of robotic process automation (RPA) tools;
transform in real-time, by one or more embedding models, the log data into vectors for storage in a vector database;
receive, via a user interface, a user query that identifies at least one RPA tool of the plurality of RPA tools;
perform a search of the vector database based on the user query to obtain a set of vectorized log data associated with the at least one RPA tool;
generate a prompt based on the user query and the set of vectorized log data;
generate, by one or more generative AI models, based on the prompt, one or more insights related to the at least one RPA tool; and
transmit the one or more insights to a user device for display.
